(19) United States
(12) Patent Application Publication
(10) Pub. No.: US 2026/0329669 A1
(43) Pub. Date: Oct. 22, 2026

(54) SYSTEMS AND METHODS FOR TRAINING REQUEST/RESPONSE APPLICATIONS ON SERIAL REQUEST/RESPONSE CYCLES

(71) Applicant: The Bank of New York Mellon, New York, NY (US)

(72) Inventors: Ace GAMBOA, New York, NY (US); Anthony QUIZON, New York, NY (US); Juan ESTRELLA, New York, NY (US); Mahendra BHAWSAR, Maharashtra (IN)

(73) Assignee: The Bank of New York Mellon, New York, NY (US)

(21) Appl. No.: 19/186,603

(22) Filed: Apr. 22, 2025

(51) Int. Cl. G06F 9/54

(52) U.S. Cl. CPC G06F 9/54

(57) ABSTRACT

Systems and method for training request/response applications on serial request/response cycles. For example, the system may receive a first request, wherein the first request has a first payload characteristic corresponding to a first cycle cluster. The system may generate for each remaining request in a plurality of requests a respective alternative payload characteristic corresponding to the first cycle cluster. The system may determine a cycle completion criterion for a first response/request cycle based on the first cycle cluster. The system may assign the cycle completion criterion to each of the plurality of requests. The system may update a first request/response application by: inputting each of the plurality of requests into the first request/response application to receive respective responses; comparing each of the respective responses to the cycle completion criterion; and modifying parameters of the first request/response application based on comparing each of the respective responses to the cycle completion criterion.

### BACKGROUND

Developing request/response applications, such as AI-powered chatbots, presents significant challenges, particularly in ensuring their conversational effectiveness and the accuracy of responses provided to users. As chatbots evolve to engage in human-like interactions, they must be capable of asking follow-up questions, requesting missing information, and seeking user confirmation based on the context of the conversation. However, validating the accuracy and relevance of chatbot responses within such dynamic interactions is a complex task.

One of the primary challenges in testing chatbots is the unpredictability of conversations. Unlike traditional software testing, where predefined inputs generate expected outputs, chatbot interactions are fluid and can take unexpected turns, making it difficult to anticipate and validate every possible exchange. Additionally, chatbots must accurately interpret user intent while maintaining contextual awareness over multiple interactions. A misinterpretation of intent can lead to irrelevant or incorrect responses, negatively affecting user experience. Another challenge arises from the variability in user input, as people phrase similar requests differently, use slang or abbreviations, or provide incomplete information. A chatbot must be robust enough to handle such diversity while ensuring meaningful responses.

Furthermore, assessing chatbot responses is inherently subjective. Unlike deterministic software systems where outputs can be definitively classified as correct or incorrect, chatbot responses may vary in phrasing or tone, making evaluation more nuanced. A response may be technically correct but still feel unnatural or unhelpful to the user. This subjectivity complicates the process of automated testing. Additionally, scalability poses a significant challenge—manually testing chatbots across diverse topics, conversation flows, and user behaviors is time-consuming and resource-intensive. Automating this process is challenging due to the inherently unpredictable nature of human conversations.

### SUMMARY

Systems and methods are described herein for novel uses and/or improvements to request/response applications. As one example, systems and methods are described herein for mitigating the inherently unpredictable nature of human conversations used by a first request/response application to train a second request/response application. For example, the system may use two request/response applications interacting with each other to generate both input and outputs that may be used as training data to adjust the parameters of request/response applications. By using two request/response applications that interact with each other the request/response applications may increase the amount of training data, allowing applications to better generalize across diverse linguistic patterns, contexts, and user intents. Expanding the dataset exposes the model to a wider variety of ways in which users phrase their requests, including different sentence structures, colloquialisms, abbreviations, and regional dialects. By incorporating more training examples, particularly those that include edge cases, ambiguous queries, and multi-turn conversations, the applications can improve their ability to recognize and adapt to unpredictable inputs.

However, while the use of a first request/response application to train a second request/response application may allow the training data amount to increase, it nonetheless creates multiple novel technical problems. First, the system needs to obtain this additional data, which may not be available. For example, the required training data may require human conversations featuring numerous examples of each of the edge cases, ambiguous queries, and/or multi-turn conversations as well as examples of each of these with different sentence structures, colloquialisms, abbreviations, and/or regional dialects. Secondly, even if the examples are available, the system needs to label each of these examples with not only the topic cluster involved, but also the criteria used to determine whether the interaction was successful. Only upon determining whether the interaction was successful, can the data be used to update and/or refine the request/response application.

To solve the first technical problem, the system may receive an example request for a request/response application. The system may then generate additional examples of that request with variations that cover the numerous edge cases, ambiguities, and/or nuances. The system may cluster each of these examples with the same request/response cycle cluster. The system may then solve the second technical problem by assigning cycle completion criteria based on a request's inclusion in the cluster. By using this approach, the system may receive the data used to determine how to update and/or refine the request/response application while minimizing the data gathering and data processing limitations discussed above.

In some aspects, systems and method for training request/response applications on serial request/response cycles. For example, the system may receive a first request, wherein the first request has a first payload characteristic corresponding to a first cycle cluster. The system may generate for each remaining request in a plurality of requests a respective alternative payload characteristic corresponding to the first cycle cluster. The system may determine a cycle completion criterion for a first response/request cycle based on the first cycle cluster. The system may assign the cycle completion criterion to each of the plurality of requests. The system may update a first request/response application by: inputting each of the plurality of requests into the first request/response application to receive respective responses; comparing each of the respective responses to the cycle completion criterion; and modifying parameters of the first request/response application based on comparing each of the respective responses to the cycle completion criterion.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows illustrative diagram of a user interface, in accordance with one or more embodiments.

FIG. 2 shows illustrative diagram for generating clusters of requests with alternative payload characteristics, in accordance with one or more embodiments.

FIG. 3 shows illustrative components for a system used training request/response applications, in accordance with one or more embodiments.

FIG. 4 shows illustrative components for a system using a model to update a request/response application, in accordance with one or more embodiments.

FIG. 5 shows a flowchart of the steps involved in training request/response applications on serial request/response cycles, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Systems and methods are described herein for mitigating the inherently unpredictable nature of human conversations used by using a first request/response application (or outputs thereof) to train the request/response application or another request/response application. A request/response application may be a system designed to process user-initiated requests and generate appropriate responses in real time. These applications may follow a structured interaction model where a user inputs a query, command or message, and the system analyzes the input, processes it, and returns a relevant response. Common examples include chatbots, virtual assistants, messaging platforms, and customer support systems. Such applications can leverage rule-based logic, machine learning models, or natural language processing (NLP) to interpret user input, retrieve or generate responses, and maintain context in multi-turn conversations.

In a request/response application, a request may be an input or query initiated by a user, request/response application, etc., while a response is the system-generated reply that addresses the request. The request serves as the trigger for the system to process information, interpret user intent, and generate an appropriate response. Requests can take various forms, including typed text, voice commands, API calls, or structured data inputs, depending on the nature of the application. For example, in a chatbot, a request might be a user asking, “What's the weather like today?”, in response, the system would analyze the input, retrieve relevant weather data, and generate a reply such as, “The current temperature is 72 °F with clear skies.”.

The response may be the output produced by the system (e.g., the same of a different request/response application) based on the request. The response may be a simple text reply, a dynamically generated answer, an action (such as booking a flight or playing a song), or even a series of follow-up questions to clarify ambiguous user input. The quality and accuracy of the response depend on how well the system understands the request and processes relevant data. More advanced request/response applications, such as AI-powered chatbots or virtual assistants, employ natural language processing (NLP) and machine learning to improve response accuracy and conversational fluidity.

The interaction between request and response forms the foundation of communication in such applications, determining how effectively they can engage users, provide information, and assist with tasks. A well-designed request/response system must handle a wide variety of user inputs, manage context in multi-turn conversations, and generate meaningful responses that enhance the user experience.

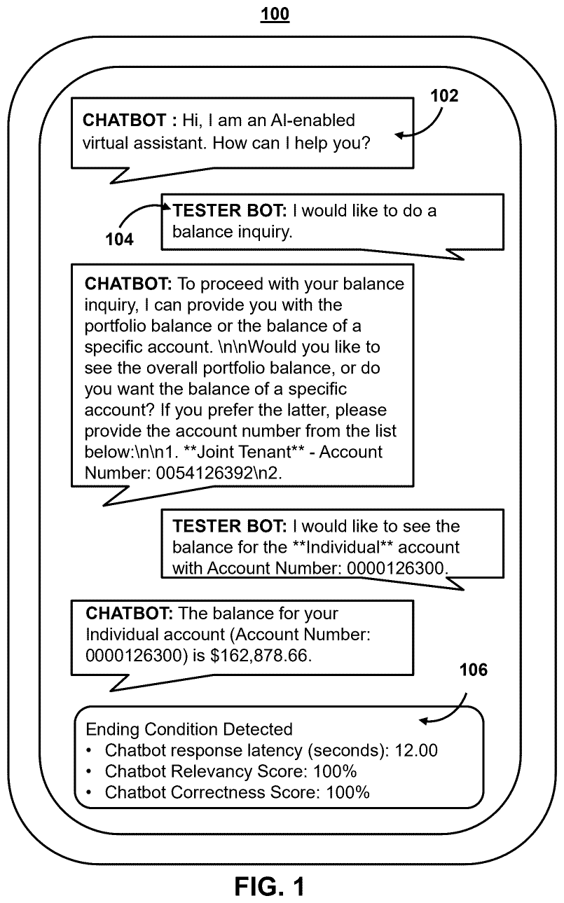

FIG. 1 shows illustrative diagram of a user interface comprising a request/response application, in accordance with one or more embodiments. A system may use two request/response applications interacting with each other to refine the model powering a request/response application by generating both input and output data that can be used for training. This interaction allows the system to produce a diverse set of conversational exchanges, which may be used to adjust model parameters and improve response accuracy. By having two applications engage in simulated conversations, the system can generate a high volume of training data without relying solely on human input. This method may increase the variety of linguistic patterns, contexts, and user intents present in the dataset, allowing the model to generalize more effectively across different conversational scenarios. For example, the system may use two request/response applications interacting with each other to generate both input and outputs that may be used as training data to adjust the parameters of request/response application. By using two request/response applications that interact with each other the request/response applications may increase the amount of training data, allowing applications to better generalize across diverse linguistic patterns, contexts, and user intents. Expanding the dataset exposes the model to a wider variety of ways in which users phrase their requests, including different sentence structures, colloquialisms, abbreviations, and regional dialects. By incorporating more training examples, particularly those that include edge cases, ambiguous queries, and multi-turn conversations, the applications can improve their ability to recognize and adapt to unpredictable inputs.

As shown in FIG. 1, user interface 100 may comprise a request/response cycle between a first entity (e.g., “Chatbot”) and a second entity (e.g., “Tester Bot”). A user interface (UI) may comprise a point of interaction between a user, a system, and/or one or more other entities, allowing communication and control. It may encompass all the visual, auditory, and/or interactive elements that facilitate user engagement, making it easier to input commands, receive responses, and navigate the system. In the context of a chatbot, a user interface may comprise of a messaging window where users can type or speak queries, while the chatbot processes the input and generates responses. This interface may include text-based input fields, buttons for quick responses, voice recognition capabilities, or graphical elements such as icons and animations to enhance user experience.

A system may generate user interface 100 to facilitate a request/response cycle between a first entity (e.g., “Chatbot”) and a second entity (e.g., “Tester Bot”), visually representing their interactions in a structured format. The user interface may be designed to display a sequential exchange of requests and responses, allowing users to monitor and analyze the conversation flow. In this setup, the first entity initiates a request 102, which is processed and responded to by the second entity 104. This cycle continues iteratively, forming a serial request/response loop that can be tracked through the interface.

User interface 100 may include elements that clearly distinguish between the two entities, such as chat bubbles, color coding, or labels to indicate whether the message originates from the chatbot or the tester bot. Additionally, the interface may present timestamps, message status indicators, and response evaluation metrics to assess the accuracy, relevancy, and coherence of each response. To enhance usability, the system may provide options for users to pause, restart, or adjust the conversation flow, allowing for iterative testing and fine-tuning of chatbot performance.

In a testing scenario, user interface 100 may also incorporate analytical tools to measure key performance indicators such as response latency, sentiment analysis, and context retention. By systematically logging and displaying each request/response exchange, the system can help developers identify inconsistencies, improve natural language processing capabilities, and refine chatbot interactions. This structured visualization of the request/response cycle not only aids in debugging and model training but also enhances the overall development process by providing insights into how the chatbot adapts to different inputs over time.

For example, user interface 100 also comprises output 106. Output 106 may comprise an alert that an ending condition (e.g., a condition for ending a request/response cycle) has been detected. Output 106 may also include other metrics such as a response latency, a response relevancy score, and/or a correctness score. The system may generate an output 106 to indicate that an ending condition for a request/response cycle has been detected, providing insights into the chatbot's performance during the interaction. This output may include an alert signaling that a predefined stopping criterion—such as reaching a maximum number of exchanges, detecting an unresolved query, or satisfying a testing objective—has been met. The system may determine these conditions based on conversation length, response accuracy, or the chatbot's ability to maintain context and generate meaningful replies.

Additionally, output 106 may present various performance metrics to evaluate the effectiveness of the request/response cycle. For example, it may display response latency, measuring the time taken for the chatbot to process a request and generate a response. A response relevancy score may be calculated based on semantic similarity, intent matching, or predefined evaluation criteria to assess how well the chatbot's replies align with expected answers. A correctness score may also be included, possibly derived from comparisons with ground truth responses or human-labeled data, to indicate the accuracy of the chatbot's output.

To enhance usability, the system may generate output 106 in a structured format, such as a summary dashboard, log file, or visual graph, allowing developers to analyze performance trends and identify areas for improvement. In some implementations, this output may trigger automated debugging suggestions, highlighting problematic responses or recommending adjustments to model parameters. By systematically capturing and presenting this data, the system may streamline chatbot evaluation, facilitate iterative improvements, and contribute to more reliable and human-like conversational interactions.

Expanding the dataset through such interactions may expose the model to a broader range of ways users phrase their requests, including variations in sentence structure, colloquialisms, abbreviations, and regional dialects. Additionally, by generating conversations that include edge cases, ambiguous queries, and multi-turn interactions, the system may improve its ability to handle unpredictable inputs. These exchanges can help the model recognize subtle shifts in context, refine its natural language understanding, and generate more coherent responses. However, while the use of a first request/response application to train a second request/response application may allow the training data amount to increase, it nonetheless creates multiple novel technical problems. First, the system needs to obtain this additional data, which may not be available. For example, the required training data may require human conversations featuring numerous examples of each of the edge cases, ambiguous queries, and/or multi-turn conversations as well as examples of each of these with different sentence structures, colloquialisms, abbreviations, and/or regional dialects. Secondly, even if the examples are available, the system needs to label each of these examples with not only the topic cluster involved, but also the criteria used to determine whether the interaction was successful. Only upon determining whether the interaction was successful, can the data be used to update and/or refine the request/response application.

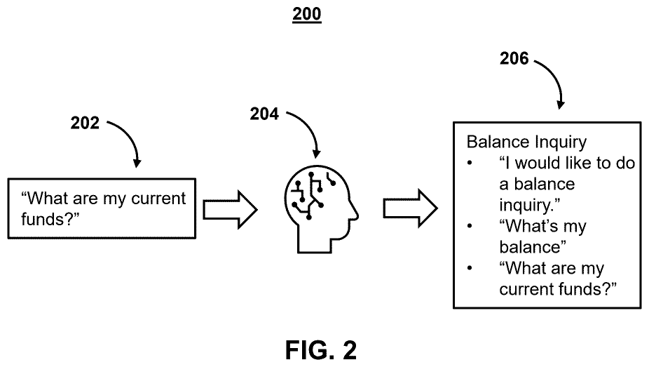

FIG. 2 shows illustrative diagram for generating clusters of requests with alternative payload characteristics, in accordance with one or more embodiments. For example, system 200 shows the receipt of request 202 by model 204 in order to create a plurality of requests in the same cluster cycle as request 202. For example, the system may receive an example request for a request/response application. The system may then generate additional examples of that request with variations that cover the numerous edge cases, ambiguities, and/or nuances. The system may cluster each of these examples with the same request/response cycle cluster.

System 200 may receive a request 202 from model 204, which is used to generate a plurality of requests within the same cluster cycle (e.g., cluster 206) as request 202. This process allows the system to create multiple variations of the original request, ensuring comprehensive coverage of diverse linguistic patterns, potential ambiguities, and edge cases. For example, when the system receives an initial request intended for a request/response application, it may analyze the structure and intent of the input and generate additional requests that incorporate slight modifications, such as rewording, introducing typos, using different sentence structures, or including missing or extra context. These variations may help the model learn how to handle unpredictable user inputs while maintaining accuracy and relevance in its responses.

To organize these generated requests efficiently, system 200 may group them into a request/response cycle cluster, ensuring that all variations of the original request remain within the same analytical context. This clustering may help the system compare how the model responds to different phrasings of the same underlying intent, identifying inconsistencies, response gaps, or weaknesses in comprehension. The system may also use clustering to assess model robustness, ensuring that responses remain consistent and contextually appropriate regardless of minor changes in input.

Furthermore, clustering requests within the same cycle may enhance the training and evaluation process by allowing developers to test model performance across a diverse yet related set of scenarios. By systematically generating and grouping request variations, system 200 may improve the adaptability of request/response applications, enabling them to handle real-world user interactions more effectively. This approach may contribute to refining natural language understanding, reducing errors in response generation, and ensuring a more reliable conversational AI experience.

The system may receive the data used to determine how to update and/or refine the request/response application while minimizing the data gathering and data processing limitations discussed above. Using two request/response applications in training may enhance the chatbot's ability to self-correct, detect inconsistencies, and refine response generation strategies. One application may act as a user while the other acts as the chatbot, creating iterative feedback loops where generated responses are evaluated, adjusted, and improved over time. This process may help fine-tune conversational flow, response coherence, and contextual awareness, making the chatbot more effective in real-world interactions. While human oversight may still be necessary for evaluating nuanced responses, automating a portion of the training process through application-to-application interactions may significantly accelerate model refinement and improve overall performance.

A request/response cycle cluster (e.g., cluster 206) may be a grouping of related request/response interactions that share a common intent, theme, or goal within a request/response application. The purpose of clustering these cycles is to systematically analyze how the system responds to different variations of similar requests, ensuring consistency, robustness, and adaptability across different user inputs. Each cluster may contain multiple request/response pairs that stem from variations of a base request, including rewordings, paraphrased queries, ambiguous formulations, or edge cases. By organizing interactions into clusters, a system may more effectively evaluate response accuracy, contextual understanding, and adaptability to nuanced inputs.

To determine these clusters, the system may analyze the intent and linguistic patterns of each request. Intent classification models, topic modeling techniques, or embeddings-based similarity measures (e.g., cosine similarity in vector space representations) may be used to identify and group related requests into clusters. The system may consider various factors, such as the semantic similarity of different requests, the presence of specific keywords, or the functional goal of the user's input. For instance, a cluster related to weather inquiries might include requests like “What's the weather like?”, “Tell me today's forecast.”, and “Will it rain later?”, all of which share a common intent of retrieving weather information.

Additionally, the system may dynamically refine and expand clusters based on real-time user interactions, feedback, or model performance evaluation. By continuously updating these clusters with new request variations, the system may improve its ability to generalize across different phrasings, slang, or regional dialects. Furthermore, clustering requests around specific intents allows the system to test and optimize different response strategies, ensuring that the chatbot or request/response application maintains relevance and coherence across a wide range of user inputs. Ultimately, clustering request/response cycles enhances training, testing, and refinement processes, leading to a more resilient and intelligent conversational AI system.

A payload for a request may refer to the content or data transmitted as part of the request in a request/response application. It may contain essential information needed for the system to process the request and generate an appropriate response. The payload can vary depending on the nature of the request and the type of application handling it. For example, in a chatbot, the payload may include a user's message, metadata such as language settings or user preferences, and contextual information from previous interactions. In an API request, the payload may consist of structured data in formats like JSON or XML, containing parameters, authentication tokens, or query details.

The system processing the request typically extracts and interprets the payload to determine user intent and generate a meaningful response. Depending on the complexity of the application, the payload may also include optional fields, such as timestamps, session identifiers, or contextual tags that help maintain continuity in multi-turn conversations. In some cases, the payload may be enriched with additional data, such as location information or sentiment analysis results, allowing for more context-aware and personalized responses.

Since the payload is critical for accurate processing, the system may implement validation mechanisms to ensure its integrity and correctness. This validation may involve checking for required fields, handling malformed inputs, or filtering out irrelevant or potentially harmful data. Additionally, payloads may be optimized to balance richness of information with efficiency, ensuring that request/response applications can process interactions quickly while maintaining high accuracy. By structuring and managing payload data effectively, a system can enhance its ability to interpret and respond to user requests in a reliable and contextually aware manner.

A payload characteristic for a request may refer to specific attributes or properties of the request's content that may influence how the system processes and responds to it. These characteristics may include factors such as data format, structure, length, complexity, intent type, and contextual information. For example, in a chatbot application, a payload characteristic may indicate whether the request is a simple factual inquiry (e.g., “What time is it?”) or a multi-turn conversational request requiring context retention (e.g., “Can you remind me about my meeting later?”). In an API-based request/response application, payload characteristics may specify whether the data is structured (e.g., JSON, XML) or unstructured (e.g., natural language text), as well as the presence of optional parameters or metadata.

Certain characteristics may also define the validity and completeness of a request payload. The system may assess whether required fields are present, whether the request includes ambiguous phrasing that needs clarification, or whether it contains unexpected data types. Additionally, intent classification may be a key payload characteristic, helping the system determine whether a request is related to a known category, such as customer support, product inquiries, or troubleshooting.

Another important aspect of payload characteristics is their impact on response generation and system performance. A request with a minimal payload (e.g., “Weather?”) may require the system to infer missing details, while a detailed request (e.g., “What is the weather forecast for New York this Friday at 3 PM?”) provides explicit parameters that simplify response generation. The system may also analyze characteristics like sentiment, urgency, or domain specificity to tailor its response accordingly.

By identifying and managing payload characteristics effectively, a request/response application may optimize processing efficiency, improve response accuracy, and enhance the overall user experience. Understanding these characteristics helps the system adapt to diverse inputs, handle variations in user communication styles, and maintain robust conversational interactions.

A payload characteristic of a request may be used to determine the appropriate request/response cycle cluster by analyzing key attributes such as intent, data structure, complexity, and contextual dependencies. When a request is received, the system may first examine its payload characteristics to classify it into a relevant category. For example, a request asking, “What is the weather like today?” has a payload characteristic indicating a factual inquiry, which may be clustered with other weather-related requests such as “Will it rain tomorrow?” or “Give me today's forecast.” By grouping requests with similar payload characteristics into a shared request/response cycle cluster, the system ensures that related interactions are processed and evaluated together.

Payload characteristics such as intent type, specificity, and format may also help the system refine clusters further. If a request is highly structured and provides explicit parameters, such as “What will be the temperature in New York at 5 PM?”, it may be clustered separately from more ambiguous or open-ended weather-related requests, such as “Is it nice outside?”. Similarly, requests that require multi-turn interactions or contextual understanding may form a distinct cluster from single-turn, straightforward queries.

Additionally, the system may use natural language processing (NLP) techniques to assess payload characteristics, identifying key terms, sentiment, or domain-specific information to match the request with the most relevant cluster. This clustering approach may improve training, testing, and response optimization by allowing models to learn from similar interactions, detect inconsistencies, and improve accuracy over time. By leveraging payload characteristics for clustering, a request/response application may enhance its ability to generalize across different user inputs while maintaining high relevance and coherence in its responses.

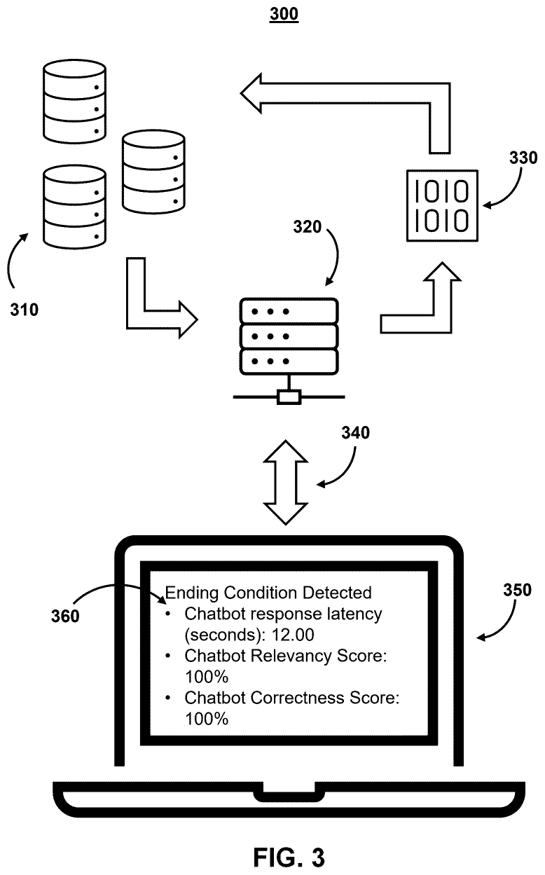

FIG. 3 shows illustrative components for a system used training request/response applications, in accordance with one or more embodiments. For example, FIG. 3 may show illustrative components for training request/response application by determining one or more cycle completion criteria. As shown in FIG. 3, system 300 may include device 310. Device 310 (as well as the other devices and components described herein) may comprise electronic storage. Electronic storage devices are systems designed to electronically store information in various formats and media. These devices may utilize non-transitory storage and/or computer-readable media to retain data and can include both system storage, which is integrally provided within servers or client devices (e.g., substantially non-removable storage), and removable storage that can be connected to servers or client devices through interfaces such as USB ports, FireWire ports, or disk drives. Electronic storage media encompasses a wide range of technologies, including optically readable storage media like optical disks, magnetically readable storage media such as magnetic tapes, hard drives, and floppy disks, as well as electrical charge-based storage media like EEPROM and RAM. Solid-state storage media, such as flash drives, are another common type of electronic storage. Additionally, virtual storage resources, including cloud storage, virtual private networks (VPNs), and other virtualized systems, are considered part of electronic storage. These devices are capable of storing various forms of data, including software algorithms, information processed or determined by processors, data obtained from servers or client devices, and other essential information that supports the functionality of various processes.

System 300 may compare the content of responses—such as predicted values, predicted intents, and generated outputs from device 320—to known reference data stored in device 310 by leveraging various computational techniques. This comparison process may involve natural language processing (NLP), machine learning models, or rule-based evaluations to assess how closely the generated responses align with expected outcomes. The system may analyze the semantic similarity between predicted and reference responses using vector-based text embeddings or similarity metrics such as cosine similarity, BLEU scores, or ROUGE scores, ensuring that the chatbot's output conveys the intended meaning accurately.

To evaluate predicted intents, the system may use an intent classification model to categorize the chatbot's response and compare it against the expected intent stored in device 310. If the predicted intent matches the expected intent within an acceptable confidence threshold, the response may be considered correct; otherwise, the system may flag discrepancies for further analysis. Additionally, the system may compare entity recognition results, ensuring that key details (such as names, dates, or numerical values) extracted from the chatbot's response correspond to the expected values in the reference dataset.

Beyond direct content comparison, system 300 may also analyze context retention and conversation flow, determining whether the chatbot appropriately maintains context across multiple turns in the request/response cycle. The system may track the consistency of responses over time, checking for logical coherence and relevance. If discrepancies are detected, the system may trigger corrective measures, such as logging errors, adjusting model parameters, or prompting further training on ambiguous cases.

By systematically comparing chatbot-generated responses with known data, system 300 may refine the accuracy, reliability, and contextual awareness of the request/response application. This ongoing evaluation process may contribute to model improvement, reducing errors and enhancing the chatbot's ability to engage in meaningful human-like conversations.

System 300 may determine a cycle completion criterion 360 by comparing the content of responses—such as predicted values, predicted intents, or other generated outputs on device 320—to known reference data stored on device 310. This comparison may involve evaluating whether the chatbot's predicted responses align with expected values, predefined intents, or previously verified outputs. By analyzing these comparisons, the system may determine whether the chatbot has successfully completed the request/response cycle or whether additional iterations are required to refine its performance. The evaluation process may involve natural language processing (NLP) techniques, similarity scoring, or direct matching against ground truth datasets to assess response accuracy and relevance.

Additionally, the system may determine that an ending condition has been met based on specific stopping criteria encoded within criterion 360. These conditions may include factors such as reaching a predefined number of exchanges, detecting that the chatbot cannot generate a meaningful response, or confirming that a testing objective—such as verifying response consistency across multiple variations of a request—has been satisfied. Criterion 360 may also incorporate performance metrics, including response latency (the time taken to generate a response), response relevancy score (a measure of how well the response aligns with the intent of the request), and/or a correctness score (a confidence metric indicating the accuracy of the generated response).

When an ending condition is met, the system may generate an alert or summary report indicating that the request/response cycle has concluded. This output may provide insights into the chatbot's conversational abilities, highlighting strengths and areas needing improvement. In some implementations, the system may also dynamically adjust its criteria based on real-time performance, refining its stopping conditions to optimize response evaluation. By systematically monitoring and assessing chatbot responses through cycle completion criteria, system 300 may enhance the overall quality, accuracy, and reliability of a request/response application, ensuring it adapts effectively to diverse conversational scenarios.

System 300 may generate metrics such as correctness, accuracy, response relevancy, and confidence scores by systematically comparing the content of responses generated on device 320 to known reference data stored in device 310. This evaluation process may involve various techniques, including statistical analysis, natural language processing (NLP) models, and machine learning-based scoring methods to assess the chatbot's performance across multiple dimensions.

To measure correctness, the system may directly compare the predicted response to an expected or ground truth response using string matching, semantic similarity scoring, or classification-based evaluations. If the chatbot's response closely aligns with the reference data, it may receive a high correctness score, while deviations, omissions, or inaccuracies may result in lower scores. Similarly, accuracy may be determined by evaluating how frequently the chatbot generates correct responses across multiple interactions, calculating a percentage of correctly matched responses over total test cases.

For response relevancy, system 300 may employ NLP similarity metrics such as cosine similarity, BLEU scores, ROUGE scores, or BERT-based embeddings to determine how semantically similar the chatbot's response is to the expected answer. Higher similarity scores may indicate that the chatbot has effectively captured the intent and meaning of the request, even if the exact wording differs. Additionally, intent classification accuracy may be measured by comparing the predicted intent of the chatbot's response against the expected intent stored in device 310, helping assess whether the chatbot correctly interprets user queries.

Other performance metrics may include latency, which measures the time taken to generate a response, and confidence scores, which reflect the model's certainty in its predictions. The system may aggregate these metrics into a performance evaluation framework, providing insights into areas where the chatbot excels and where improvements may be needed. By continuously refining these evaluation methods, system 300 may enhance the chatbot's ability to generate relevant, accurate, and contextually appropriate responses, ultimately improving user experience and conversational reliability.

In some embodiments, system 300 and/or one or more components herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

System 300 may send and/or receive data to device 320, which may generate output 330. System 300 may facilitate the transfer of data between device 310 and device 320, enabling the generation of output 330. Device 310, which functions as a storage device, holds the data that is sent to device 320, such as a CPU. A CPU, or Central Processing Unit, is the primary component of a computer responsible for executing instructions and performing computations necessary for various processes and functions. The CPU may interpret and execute instructions from programs and operating systems through a cycle of fetching, decoding, and executing commands. This cycle begins with the CPU retrieving an instruction from the system's memory, followed by decoding it to understand the required operation, and finally executing it by performing arithmetic, logical, control, or input/output tasks. The CPU relies on its internal components, including the arithmetic logic unit (ALU) for mathematical operations, the control unit (CU) for directing data flow, and registers for temporary data storage. By leveraging its clock speed and multiple cores in modern processors, the CPU can execute complex processes efficiently, enabling the functionality of applications and systems.

Device 320 processes the received data by implementing one or more applications and/or models to perform specific tasks or computations. These applications or models analyze, transform, or process the input data to produce the desired output 330. This output may represent the results of calculations, simulations, or other operations conducted by the applications or models on device 320. The system ensures seamless communication between the devices, allowing for efficient data transfer and output generation.

Output 330 may represent the result of processing data or executing instructions. In the case of a CPU, outputs can include processed data, computational results, or responses to input commands. For models, outputs often consist of predictions, classifications, decisions, or other data derived from the model's algorithms or trained parameters. Once generated, the output is typically stored in a suitable storage medium, such as system memory (RAM), a local storage device (e.g., hard drive or SSD), or a networked storage system. This stored output can then be used in various ways depending on the application. For example, it might be displayed to users as visual or textual information, serve as input for subsequent computational tasks, or be transmitted to other devices or systems for further processing. The efficient storage and utilization of outputs are essential for enabling real-time responsiveness, supporting iterative processes, and ensuring seamless integration with larger workflows or systems.

System 300 may also include terminal 350. Terminal 350 may include a user interface that may be used to interact with one or more components in system 300. As referred to herein, a “user interface” may comprise a human-computer interaction and communication in a device, and may include display screens, keyboards, a mouse, and the appearance of a desktop. For example, a user interface may comprise a way a user interacts with an application or a website. As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

Users may interact with a system through various types of terminals in system 300 (although only a single terminal is shown for simplicity), which serve as access points for communication and control. Terminals can include traditional devices such as desktop computers, laptops, and workstations, which often feature input peripherals like keyboards and mice and output peripherals like monitors. Mobile devices, such as smartphones and tablets, provide touchscreens and voice recognition as primary interaction methods, offering portability and convenience. Specialized terminals, such as kiosks, point-of-sale (POS) systems, or industrial control panels, are designed for specific applications, often with simplified interfaces like touchscreens or dedicated buttons. Wearable devices, including smartwatches and augmented reality (AR) glasses, offer hands-free interaction via gestures, voice commands, or sensors. Users may also engage with systems through virtual assistants, using voice-based interactions, or through command-line interfaces for text-based commands. Other interaction methods include haptic feedback, biometric inputs (e.g., fingerprint or facial recognition), and adaptive technologies like eye-tracking for users with disabilities. These diverse terminals and interaction methods enable systems to cater to various use cases, environments, and user preferences.

An I/O (Input/Output) path refers to the communication pathway that facilitates the exchange of data between computing devices or systems. I/O path 340, for instance, may encompass a variety of communication networks such as the Internet, mobile phone networks, mobile voice or data networks like 5G or LTE, cable networks, public switched telephone networks (PSTN), or combinations of these. These networks provide the infrastructure for transmitting data across different mediums. The I/O path can also include specific communication paths, such as satellite links, fiber-optic connections, cable connections, Internet-based communication paths (e.g., IPTV), and free-space links that support wireless or broadcast signals. In addition to external communication networks, computing devices may feature internal communication paths that integrate hardware, software, and firmware components. For example, multiple computing devices can operate as part of a unified cloud-based platform, leveraging interconnected communication paths to function collectively. These I/O paths are essential for ensuring seamless data flow, supporting applications, and enabling distributed computing environments.

In some embodiments, system 300 may be a cloud system. A system structured as a cloud system is designed to provide scalable, on-demand access to computing resources and services over the Internet or other networks. In a cloud system, multiple interconnected servers, data centers, and storage devices work together to deliver virtualized computing power, storage, and applications. These resources are hosted remotely in distributed locations, creating a virtualized environment that can dynamically allocate resources based on user demands. The cloud system is typically organized into three main service models: Infrastructure as a Service (IaaS), which offers virtualized hardware and network resources; Platform as a Service (PaaS), which provides tools and frameworks for application development; and Software as a Service (SaaS), which delivers software applications to users. The system relies on communication paths, including high-speed fiber-optic networks, satellite links, and wireless connections, to enable seamless interaction between users and the cloud infrastructure. Advanced management tools and load-balancing mechanisms ensure reliability, efficiency, and fault tolerance within the system. This structure allows users to access computing resources flexibly and cost-effectively without the need to maintain physical hardware.

In some embodiments, system 300 may use one or more APIs. An API, or Application Programming Interface, is a set of rules and protocols that allows different components within a system, such as system 300, to communicate and interact seamlessly. APIs define how software applications, services, or devices can request and exchange data, enabling interoperability between components regardless of their underlying technologies. Within a system, an API acts as a bridge between different modules, such as databases, user interfaces, or external services, facilitating the flow of information and the execution of commands.

For instance, in system 300, an API might enable device 310, a data storage component, to provide information to device 320, a processing unit. Device 320 could use the API to request specific data, execute operations, or send processed results back to another component. The API specifies the format and structure of the requests and responses, such as using JSON or XML, and enforces security protocols like authentication tokens or encryption to ensure secure communication.

APIs can also enable external systems to interact with system 300. For example, a financial application could use an API to query account balances, initiate transactions, or retrieve fraud detection reports generated by a model housed within the system. By standardizing interactions, APIs simplify the integration of diverse components, improve scalability, and support modular system designs, making it easier to expand or update individual parts without disrupting the entire system.

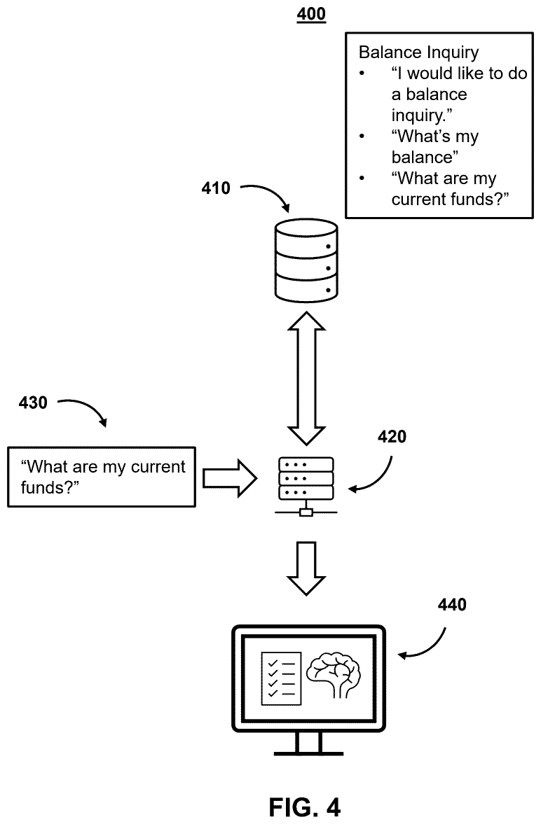

FIG. 4 shows illustrative components for a system using a model to update a request/response application, in accordance with one or more embodiments. For example, FIG. 4 may show illustrative components for training request/response applications. System 400 may comprise one or more artificial intelligence and/or machine learning models. Artificial intelligence (AI) and machine learning (ML) models are computational systems designed to perform tasks that typically require human intelligence, such as recognizing patterns, making predictions, and learning from data. AI models encompass a broad range of techniques, including rule-based systems, natural language processing, and deep learning, to simulate intelligent behavior. Machine learning, a subset of AI, focuses on developing algorithms that allow models to learn and improve their performance from data without being explicitly programmed. ML models are trained on large datasets to identify patterns and relationships, enabling them to make predictions, classify information, or automate decision-making processes. These models can be supervised, where they learn from labeled data; unsupervised, where they identify patterns in unlabeled data; or reinforced, where they learn through trial and error using feedback. Examples of a model may include neural networks for image recognition, decision trees for predictive analytics, and transformers for language understanding. AI and ML models are used in various fields, such as healthcare, finance, transportation, and entertainment, to drive innovation and enhance efficiency.

It should be noted that system 400 may also include non-AI models. Non-AI models are computational or mathematical models that do not rely on artificial intelligence or machine learning techniques. Instead, they use predefined rules, equations, or algorithms to simulate processes, analyze data, or solve problems based on established principles. Examples of non-AI models include statistical models, such as linear regression and logistic regression, which are used to identify relationships between variables and make predictions; deterministic models (e.g., Newtonian mechanics or circuit analysis); and rule-based systems, where a set of predefined rules governs decision-making or problem-solving.

Non-AI models may be implemented by programming the underlying rules, equations, or algorithms directly into software or hardware. For instance, statistical models are implemented using mathematical libraries or statistical software, while rule-based systems are often coded into decision-support applications. Deterministic models can be built using simulation software or computational frameworks that apply known physical laws. These models require precise inputs and often operate in scenarios where variability is minimal or well-understood. While non-AI models lack the adaptability and learning capabilities of AI models, they are often faster, more transparent, and easier to validate, making them suitable for well-defined problems with consistent parameters.

In some embodiments, system 400 may comprise a model that requires training. A model that requires training is a machine learning (ML) or artificial intelligence (AI) model that learns patterns, relationships, or rules from a dataset to make predictions, classify information, or perform specific tasks. Training such a model involves exposing it to a labeled dataset—referred to as training data—that includes input features and corresponding outputs or labels. The model uses this data to iteratively adjust its parameters to minimize errors and improve its accuracy in predicting outputs for new, unseen inputs. Training mechanisms often rely on optimization algorithms, such as gradient descent, to update the model's weights based on a loss function, which measures the difference between predicted and actual outcomes.

Training data 410 may serve as the foundation for the model's learning. It typically consists of structured examples where each instance includes input variables (e.g., images, numerical data, or text) and desired outputs. For example, in financial services, a model designed for check cashing based on images might use training data comprising scanned check images labeled with information such as amounts, payees, or account details. During training, the model learns to recognize patterns, such as handwriting styles or printed text, and correlates them with the appropriate output.

Training data 410 may be collected from various sources. For example, the system may collect training data by gathering and organizing relevant information from various sources to build a dataset that represents the problem the model is designed to solve. This process often begins with identifying the specific objectives of the model and determining the types of data required to achieve those goals. Training data can be collected from structured databases, such as financial transaction records or customer profiles, or unstructured sources, like images, videos, text documents, or audio files. In cases where labeled data is needed, annotations or labels are added manually by human experts or automatically using tools like optical character recognition (OCR) or natural language processing (NLP) systems.

For example, in the context of check cashing, training data may include a large set of check images collected from banks, financial institutions, or customer uploads, along with corresponding metadata such as account numbers, payee details, and check amounts. Systems may also integrate data from online repositories, APIs, or real-time inputs from user interactions. Additionally, data preprocessing techniques, such as cleaning, normalization, and augmentation, are applied to ensure the quality, consistency, and diversity of the dataset. Ethical considerations and data privacy may be important during data collection to ensure compliance with regulations and protect user information. Once collected, the training data is stored in a format that facilitates efficient access and processing during the model training phase, enabling the system to learn patterns and improve its performance.

Mechanisms used for training include supervised learning, where labeled data guides the model; unsupervised learning, where the model identifies patterns in unlabeled data; and reinforcement learning, where the model learns by receiving feedback in the form of rewards or penalties. In the case of check cashing, supervised learning would be employed, as labeled images of checks provide clear examples for the model to learn from. Techniques like convolutional neural networks (CNNs) are particularly effective for analyzing image data, enabling the model to extract features like text, logos, or signatures from checks. Once trained, the model can automate tasks such as fraud detection, data extraction, or account verification in financial services, improving efficiency and accuracy.

Using training data 410, system 400 may train a model housed at device 420. For example, system 400 trains a model housed at device 420 by using training data 410 as the foundational input to guide the learning process. The system begins by feeding the training data, which consists of input-output pairs or labeled examples, into the model located on device 420. The model processes these inputs and generates predictions or outputs (e.g., a cycle completion criterion and/or metric related thereto). A loss function, designed to measure the difference between the model's predictions and the actual outputs in the training data, evaluates the accuracy of these predictions. Device 420 uses optimization algorithms, such as gradient descent, to adjust the model's parameters (e.g., weights and biases) in a way that minimizes this loss.

In some embodiments, the system houses training data, such as training data 410, comprising verbal authentications of a given passphrase by securely storing and organizing audio samples in a structured database or repository. Each entry in the training dataset typically includes recordings of users verbalizing specific passphrases, along with associated metadata such as the speaker's identity, recording date, environmental conditions, and any additional characteristics relevant to the authentication process. The data is collected in diverse scenarios to account for variations in accents, speech patterns, and background noise, ensuring robust performance of the authentication system under real-world conditions.

To maintain security and privacy, the system encrypts the training data and restricts access to authorized personnel or algorithms designed for training and evaluation purposes. The data may also be anonymized or processed to remove personally identifiable information (PII) while retaining the essential features needed for analysis. This dataset can be used to train machine learning models or voice recognition algorithms, enabling the system to accurately match incoming verbal authentications against the expected passphrase. By continuously updating and refining the training data, the system can adapt to evolving user needs and enhance the reliability of verbal authentication processes.

The training process may be iterative, meaning the system repeatedly passes the training data through the model, updates the parameters, and recalculates the loss until the model achieves a desirable level of accuracy or the loss reaches an acceptable threshold. Techniques such as batching (processing subsets of the data at a time) and epoch cycling (repeating the full dataset through the model multiple times) are often used to improve efficiency and learning. During training, device 420 may leverage computational accelerators like GPUs or TPUs to handle the intensive computations required for large-scale datasets or complex models.

For instance, if system 400 is training a model to generate metrics related to the success of a response, the training data 410 might include labeled values, known correct answers, and/or other information used to train a model to generate metrics (e.g., correctness, accuracy, etc.) based on comparing the content of responses to known data. For example, if system 400 is training a model to generate metrics related to the success of a response, its training data 410 may include a diverse set of labeled values, known correct answers, and other structured information necessary to evaluate chatbot responses. This dataset may consist of pairs of user queries and expected responses, where each response is labeled with predefined evaluation scores such as correctness, accuracy, relevancy, and confidence levels. By training on these labeled examples, the model can learn to assess chatbot-generated responses based on similarities to known correct answers and expected conversational patterns.

Additionally, training data 410 may include intent labels and classification categories, allowing the model to compare predicted intents with expected intents to determine whether the chatbot correctly understands user queries. The dataset may also contain response similarity scores, generated using techniques such as cosine similarity, BLEU scores, or BERT-based embeddings, providing a reference for evaluating how closely chatbot responses align with expected outputs. Furthermore, error annotations may be included, marking cases where responses contain factual inaccuracies, lack coherence, or fail to retain context, enabling the model to recognize and score such issues accordingly.

To enhance robustness, training data 410 may incorporate a variety of linguistic variations, including paraphrased responses, edge cases, ambiguous queries, and regional dialects, helping the model learn to evaluate chatbot responses across different conversational styles. Additionally, human-annotated feedback, where domain experts manually score chatbot responses for accuracy and relevance, may serve as a gold standard for the model to learn from. By training on this well-structured dataset, system 400 can develop a model capable of automatically generating evaluation metrics, improving the ability to monitor and refine chatbot performance over time.

During the training phase, the model iteratively adjusts its internal parameters to minimize errors in predictions, improving its ability to generalize from known data to new, unseen inputs. Once trained, the model processes incoming data by extracting and analyzing the same features it learned from the training phase. For fraud detection, it identifies anomalies such as mismatched user profiles, unusual audio characteristics, or deviations from expected patterns, flagging them for further review. For detecting AI-generated submissions, it analyzes characteristics unique to synthesized audio, such as lack of natural variability or artifacts from the generation process. Over time, as more data is processed and the model is fine-tuned, its accuracy and reliability improve, making it a powerful tool for securing authentication systems and detecting fraudulent or AI-generated inputs.

A model housed on device 420, trained using training data 410, receives input 430 and processes it to generate output 440 through a sequence of computational steps. When input 430 is provided, it is first preprocessed, if necessary, to ensure compatibility with the model's architecture. Preprocessing may include normalization, resizing (for images), tokenization (for text), or encoding data into a structured format. Once the input is prepared, it is passed into the trained model on device 420.

The model processes the input using its learned parameters, which were optimized during the training phase using training data 410. The input flows through the model's layers, where features are extracted, transformed, and combined at various stages to derive meaningful representations. For example, in a deep learning model, convolutional layers might identify patterns like edges or shapes in images, while fully connected layers aggregate these patterns to make predictions or classifications. The final output, represented as output 440, is generated in the form of predictions, classifications, or extracted information, depending on the model's purpose.

A system uses a model to detect fraud or other problems in the financial services industry by analyzing data patterns, behaviors, and transactions to identify anomalies or indicators of fraudulent activities. The model, trained on historical data, learns to differentiate between normal and potentially fraudulent activities based on features like transaction amounts, frequency, locations, or user behavior. When the system receives new data, it processes the input through the model, which evaluates the data using the patterns it has learned. If the input deviates significantly from normal behavior or matches patterns associated with known fraud, the model flags it as suspicious. For example, in wire fraud detection, a machine learning model might analyze transaction data in real time to assess factors such as the amount spent, the transfer locations, and the user's transaction history. If the model detects an unusually large wire made in a foreign country shortly after another transaction in the user's home country, it could classify the transaction as potentially fraudulent. Similarly, for check processing, the system might use image recognition models to identify signs of tampering or mismatches between the written and printed information.

Once flagged, the system can trigger automated alerts, block the transaction, or escalate the case for human review. Advanced systems may also use feedback loops to improve over time, updating the model with newly confirmed cases of fraud to enhance detection accuracy. By leveraging models to monitor and analyze large volumes of data, financial systems can efficiently identify and mitigate fraud, minimize losses, and protect users.

As described above, the model housed on device 420 may determine whether a textual phrase is suitable for generation by training on a large dataset of textual examples labeled as either appropriate or inappropriate for the intended context. During training, the model learns to identify patterns, linguistic features, and contextual cues that indicate whether a phrase aligns with predefined guidelines to prevent such a phrase from being mimicked by generative artificial intelligence and/or a potential unauthorized party, such as relevance, coherence, factual accuracy, ethical standards, or conversational appropriateness. As described, this process typically involves supervised learning, where the dataset includes human-annotated labels, and the model uses these labels to minimize errors in classification over successive iterations. In addition to linguistic features, the model may also incorporate metadata, such as context, tone, or user intent, to better assess the suitability of a phrase. Techniques like reinforcement learning with human feedback (RLHF) may also be used to refine the model further, where human evaluators provide feedback on model outputs to help it learn nuanced preferences and avoid generating harmful or nonsensical content. The ultimate goal is for the model to generalize these learned criteria to new, unseen phrases and reliably assess their appropriateness during generation of output 440.

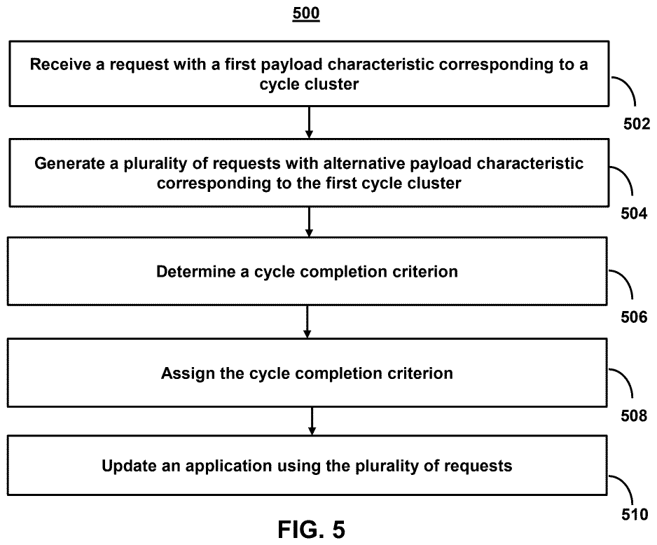

FIG. 5 shows a flowchart of the steps involved in training request/response applications on serial request/response cycles, in accordance with one or more embodiments. For example, the system may use process 500 (e.g., as implemented on one or more system components described above) in order to update and/or refine a request/response application while minimizing the data gathering and data processing limitations discussed above.

As another example, process 500 may be used for updating API request/response applications used to facilitate secure API request/response cycles across secured computer networks using a common cryptographic security protocol. For example, a cryptographic security protocol is a structured set of rules, algorithms, and procedures designed to secure digital communications and data exchanges by using cryptographic techniques. These protocols ensure confidentiality, integrity, authentication, and non-repudiation when transmitting data over potentially insecure networks, such as the internet. They define how cryptographic mechanisms, including encryption, hashing, digital signatures, and key exchange, should be applied to protect information from unauthorized access, tampering, or forgery.

Cryptographic security protocols are commonly used in various applications, including secure web browsing (HTTPS/TLS), email encryption (PGP, S/MIME), secure remote access (SSH, VPNs), and wireless communications (WPA3 for Wi-Fi security). For example, Transport Layer Security (TLS) is a widely used cryptographic protocol that encrypts internet traffic to prevent eavesdropping and data breaches. Another example is Secure Shell (SSH), which provides encrypted remote access to systems over untrusted networks.

These protocols typically involve multiple cryptographic techniques, such as public-key cryptography for secure key exchanges (e.g., RSA, Diffie-Hellman), symmetric encryption for data confidentiality (e.g., AES), and hashing for data integrity (e.g., SHA-256). They also define procedures for key management, authentication methods, and message verification to ensure that only authorized entities can participate in a secure communication session. By implementing cryptographic security protocols, organizations and individuals can protect sensitive information, prevent cyberattacks such as man-in-the-middle (MITM) attacks, replay attacks, and data breaches, and establish trust and privacy in digital transactions.

At step 502, process 500 (e.g., using one or more components described above) receives a request with a first payload characteristic corresponding to a cycle cluster. For example, the system may receive a first request, wherein the first request has a first payload characteristic corresponding to a first cycle cluster. The system may receive a first request, where the first request has a first payload characteristic that corresponds to a first cycle cluster, by analyzing the structure, intent, and content of the incoming request. When a request enters the system, it may be processed through natural language processing (NLP) models, rule-based classifiers, or intent recognition algorithms to extract key attributes that define its payload characteristics. These characteristics may include factors such as intent type, data format, complexity, required context, or semantic meaning, which help determine the appropriate request/response cycle cluster for classification. Upon identifying the first payload characteristic, the system may compare it to existing cycle clusters to determine where it belongs. This classification process may involve similarity matching, where the system evaluates whether the incoming request aligns with previously processed requests that share a similar intent or structure. For instance, if the first request is a weather-related inquiry such as “What is the forecast for tomorrow?”, the system may recognize that its first payload characteristic aligns with other weather-related queries and assign it to a weather-related request/response cycle cluster. Additionally, the system may dynamically refine its clustering approach by using machine learning models trained on historical interactions, allowing it to adapt to variations in user input. If a request contains ambiguous or edge-case characteristics, the system may either assign it to the closest matching cluster or flag it for further classification. By organizing requests into well-defined clusters based on their payload characteristics, the system may enhance response accuracy, consistency, and overall chatbot performance, ensuring that each request is processed in the most relevant conversational context.

At step 504, process 500 (e.g., using one or more components described above) generates a plurality of requests with alternative payload characteristic corresponding to the first cycle cluster. For example, the system may generate for each remaining request in a plurality of requests a respective alternative payload characteristic corresponding to the first cycle cluster. A system may generate, for each remaining request in a plurality of requests, a respective alternative payload characteristic corresponding to the first cycle cluster by systematically modifying key aspects of each request while maintaining its core intent. This process allows the system to create multiple variations of the original request, enriching the dataset with diverse linguistic structures, phrasing styles, and contextual nuances. The system may apply natural language processing (NLP) techniques, machine learning models, or rule-based transformations to generate these alternative payload characteristics dynamically.

One approach the system may use is paraphrasing, where it rewrites each request using different words or sentence structures while preserving the original intent. For example, if the first request is “What is the weather forecast for tomorrow?”, alternative payload characteristics may include variations such as “Will it rain tomorrow?”, “Tell me the weather for the next day,” or “Give me the forecast for tomorrow's weather.” Each of these variations retains the same request/response cycle cluster but introduces different linguistic patterns, improving the chatbot's ability to handle diverse user inputs.

Additionally, the system may introduce edge-case scenarios by generating alternative payload characteristics that account for ambiguous queries, incomplete information, or different contextual references. For instance, it may create requests that omit key details (e.g., “Weather for tomorrow?”), use slang (e.g., “Is it gonna rain?”), or include location-based elements (e.g., “Forecast for New York tomorrow?”). These alternative payloads help the system test how well the chatbot generalizes across variations of the same intent. The system may also use intent classification models to ensure that each generated alternative remains within the correct cycle cluster. By mapping different payload characteristics back to the same underlying request category, the system can validate that variations still align with the chatbot's trained responses. This structured approach to generating alternative payload characteristics enhances the model's robustness, adaptability, and accuracy, ensuring that the chatbot can respond effectively to a wide range of user inputs while maintaining contextual consistency.

In some embodiments, the system may generate for each remaining request in the plurality of requests the respective alternative payload characteristic corresponding to the first cycle cluster by determining a first keyword corresponding to the first payload characteristic, determining a second keyword based on the second keyword being a synonym of the first keyword, and determining a first alternative payload characteristic for a first remaining request in the plurality of requests.

For example, the system may generate, for each remaining request in the plurality of requests, a respective alternative payload characteristic corresponding to the first cycle cluster by utilizing keyword-based transformation techniques to introduce variations in request structures while preserving their core intent. This process begins by determining a first keyword that corresponds to the first payload characteristic, which may be a key term or phrase that defines the request's intent, subject, or primary focus. The system may identify this keyword using natural language processing (NLP) models, entity recognition algorithms, or predefined keyword mappings.

Once the first keyword is determined, the system then identifies a second keyword that serves as a synonym or closely related term to the first keyword. This substitution may be achieved using word embeddings, lexical databases (e.g., WordNet), transformer-based synonym generation, or context-aware similarity models. For example, if the first keyword in a request is “cost” (e.g., “What is the cost of this product?”), the system may identify “price” as a valid synonym and generate a variation such as “What is the price of this product?” while maintaining the original intent.

Using this synonym-based transformation, the system determines a first alternative payload characteristic for a first remaining request in the plurality of requests. This alternative payload characteristic modifies the original request by substituting the first keyword with the second keyword, generating a semantically similar yet structurally distinct variation. The system may then iterate this process across multiple requests, creating diverse alternative payloads that help train and evaluate the request/response application's ability to generalize across different phrasings, recognize equivalent intents, and handle linguistic variations effectively.

Additionally, the system may refine the alternative payload characteristics by applying context-aware filtering, ensuring that synonym substitutions do not alter the meaning, specificity, or expected response behavior of the request. By systematically generating these variations, the system enhances the robustness of the first cycle cluster, allowing the request/response application to improve response accuracy, reduce reliance on rigid keyword matching, and handle natural language diversity more effectively.

In some embodiments, the system may generate for each remaining request in the plurality of requests the respective alternative payload characteristic corresponding to the first cycle cluster by determining a first sentence structure and first sentence meaning corresponding to the first payload characteristic, determining a second sentence structure that is different from the first sentence structure, and determining a first alternative payload characteristic for a first remaining request in the plurality of requests based on the second sentence structure and the first sentence meaning.

For example, the system may generate, for each remaining request in the plurality of requests, a respective alternative payload characteristic corresponding to the first cycle cluster by systematically modifying the sentence structure while preserving the sentence meaning of the original request. This process ensures that the request/response application can handle diverse linguistic variations while maintaining intent recognition and response accuracy. The system first determines a first sentence structure and its associated sentence meaning, which represents the key intent and informational content of the original request. The sentence structure may include elements such as word order, grammatical composition, and syntactic dependencies, while the sentence meaning is derived from semantic representations, intent classifications, or NLP-based entity recognition.

Once the first sentence structure and meaning are identified, the system then determines a second sentence structure that differs from the first but conveys the same semantic intent. This transformation may involve syntactic restructuring techniques, such as passive-to-active voice conversions, clause reordering, question reformulations, or paraphrasing models. For example, if the original request is “How much does this product cost?” (first sentence structure), the system may generate an alternative structure like “What is the price of this product?” (second sentence structure), maintaining the same sentence meaning while altering word choice and order.

Using this newly identified second sentence structure, the system then determines a first alternative payload characteristic for a first remaining request by applying the revised structure while ensuring that the sentence meaning remains intact. This may be achieved through rule-based transformations, NLP-driven paraphrasing models (e.g., T5, BART), or machine learning-based text augmentation techniques. The system may further validate that the transformed request remains within the same cycle cluster by comparing intent similarity scores, embedding representations, or contextual word alignments to prevent unintended meaning shifts.

By systematically generating these alternative payload characteristics through sentence structure variation, the system improves the generalization capabilities of the request/response application. This enables the system to handle different phrasing styles, user-specific variations, and linguistic nuances, ensuring that chatbot models and NLP-based systems recognize and respond accurately regardless of how a request is phrased.

In some embodiments, the system may generate for each remaining request in the plurality of requests the respective alternative payload characteristic corresponding to the first cycle cluster by determining a first prompt detail level corresponding to the first payload characteristic, determining a second prompt detail level that is different from the first prompt detail level, and determining a first alternative payload characteristic for a first remaining request in the plurality of requests based on the second prompt detail level.

For example, the system may generate, for each remaining request in the plurality of requests, a respective alternative payload characteristic corresponding to the first cycle cluster by systematically modifying the prompt detail level while preserving the underlying intent of the request. This process enables the request/response application to handle variations in user input ranging from concise to highly detailed inquiries while ensuring consistent and relevant responses. The system first determines a first prompt detail level corresponding to the first payload characteristic, identifying whether the request is brief, moderately detailed, or highly specific. This classification may be based on factors such as word count, specificity of included entities (e.g., time, location, product names), or the complexity of the question structure.

After analyzing the first prompt detail level, the system then determines a second prompt detail level that differs from the first, modifying how much information is included in the request while maintaining the original intent and meaning. For example, if the original request is highly specific (e.g., “What will the weather be in New York City at 5 PM tomorrow?”), the system may generate an alternative request with reduced detail, such as “What's the weather like tomorrow?” Conversely, if the first request is broad or general (e.g., “Tell me about today's weather”), the system may increase the detail level by adding location or time-based parameters, resulting in a request like “Can you provide the hourly weather forecast for Los Angeles today?”.

Using the second prompt detail level, the system determines a first alternative payload characteristic for a first remaining request, ensuring that the modified request still corresponds to the first cycle cluster and aligns with the same response intent. The system may leverage natural language processing (NLP) techniques, paraphrasing models (e.g., GPT-based, T5, BART), rule-based detail expansion/reduction, or structured prompt engineering approaches to generate these alternative variations. To maintain accuracy, the system may also apply semantic similarity scoring, intent classification checks, and response validation methods to confirm that the transformed request remains functionally equivalent to the original.

By systematically generating alternative payload characteristics through prompt detail level variation, the system enhances the adaptability and robustness of the request/response application. This ensures that the system can effectively interpret and respond to concise and expanded queries alike, improving its ability to generalize across different user communication styles while maintaining response relevance and contextual understanding.

In some embodiments, the system may generate for each remaining request in the plurality of requests the respective alternative payload characteristic corresponding to the first cycle cluster by determining a first prompt chaining threshold corresponding to the first payload characteristic, determining a second prompt chaining threshold that is different from the first prompt chaining threshold, and determining a first alternative payload characteristic for a first remaining request in the plurality of requests based on the second prompt chaining threshold.

For example, the system may generate, for each remaining request in the plurality of requests, a respective alternative payload characteristic corresponding to the first cycle cluster by modifying the prompt chaining threshold, which determines how many sequential or dependent prompts are linked together within a request. This process enables the system to vary the complexity of request dependencies while ensuring that the intent remains aligned with the original request. The system first determines a first prompt chaining threshold corresponding to the first payload characteristic, identifying whether the request is a single standalone query or part of a multi-step conversational flow that depends on prior exchanges. This threshold may be derived based on factors such as dependency markers (e.g., pronouns, references to previous responses), logical progression of the request, or predefined conversational structures.

Once the first prompt chaining threshold is identified, the system then determines a second prompt chaining threshold that differs from the first, modifying the level of interdependency within the request. If the first request contains multiple chained prompts (e.g., “Tell me today's weather. Also, what's the temperature expected for tomorrow?”), the system may generate an alternative request by reducing the chaining threshold, breaking it into separate, standalone inquiries such as “Tell me today's weather.” and “What's the temperature expected for tomorrow?” Conversely, if the first request is independent and concise (e.g., “Show me flight options to Paris.”), the system may increase the chaining threshold by combining it with a follow-up intent, such as “Show me flight options to Paris, and also find hotels near the city center.”.

Using the second prompt chaining threshold, the system determines a first alternative payload characteristic for a first remaining request, ensuring that the modified request remains within the first cycle cluster while varying the level of interdependency between prompts. The system may generate these variations using rule-based transformations, natural language processing (NLP) models, dependency parsing techniques, or context-aware rewriting methods. Additionally, to maintain semantic integrity, the system may apply intent similarity analysis, entity tracking, and conversational coherence validation to confirm that the alternative request aligns with the original meaning.

By systematically generating alternative payload characteristics through prompt chaining threshold variations, the system enhances the request/response application's ability to manage multi-turn interactions, contextual dependencies, and varied user engagement styles. This improves the application's conversational flexibility, responsiveness to follow-up queries, and capacity to handle sequentially structured prompts effectively.

In some embodiments, the system may generate for each remaining request in the plurality of requests the respective alternative payload characteristic corresponding to the first cycle cluster by determining a first context corresponding to the first payload characteristic, determining a second context that is different from the first context, and determining a first alternative payload characteristic for a first remaining request in the plurality of requests based on the second context.

For example, the system may generate, for each remaining request in the plurality of requests, a respective alternative payload characteristic corresponding to the first cycle cluster by systematically modifying the context in which the request is framed while maintaining the original intent. This process ensures that the request/response application can handle variations in contextual information while delivering consistent and relevant responses. The system first determines a first context corresponding to the first payload characteristic, which may include implicit or explicit references to prior interactions, user preferences, session-specific data, or environmental conditions that shape the meaning of the request. The system may extract this contextual information using natural language processing (NLP) models, entity recognition, conversational memory tracking, or metadata analysis.

Once the first context is identified, the system then determines a second context that differs from the first while keeping the request's core intent intact. This alternative context may be derived by modifying user attributes, changing temporal or locational references, altering conversational history, or re-framing the request within a new situational background. For example, if the original request is “What's the best restaurant nearby?” with a first context indicating a city-based location, the system may generate an alternative request with a second context such as “What's the best restaurant in an airport?”. Similarly, if the original request is “How's the weather today?” based on the user's current location, the system may generate an alternative request by modifying the context to a different city or time frame, such as “What's the weather in New York tomorrow?”.

Using the second context, the system then determines a first alternative payload characteristic for a first remaining request, ensuring that the modified request remains within the first cycle cluster while introducing contextual diversity. The system may achieve this transformation through rule-based re-contextualization, AI-driven paraphrasing models (e.g., GPT-based, T5, BART), contextual augmentation algorithms, or user preference simulations. Additionally, the system may verify the semantic similarity between the original and modified requests using intent-matching techniques, contextual embeddings, or discourse coherence checks to prevent misinterpretations. By systematically generating alternative payload characteristics through context variations, the system improves the robustness and adaptability of the request/response application, ensuring that it can understand user requests across different scenarios, personalize responses based on shifting contexts, and handle real-world conversational diversity more effectively.

In some embodiments, the system may generate for each remaining request in the plurality of requests the respective alternative payload characteristic corresponding to the first cycle cluster by determining a first model instruction corresponding to the first payload characteristic, determining a second model instruction that is different from the first model instruction, and determining a first alternative payload characteristic for a first remaining request in the plurality of requests based on the second model instruction.

For example, the system may generate, for each remaining request in the plurality of requests, a respective alternative payload characteristic corresponding to the first cycle cluster by modifying the model instruction that governs how the request is processed while ensuring that the request's core intent remains unchanged. This process allows the system to introduce variability in response generation, improving the adaptability and robustness of the request/response application. The system first determines a first model instruction corresponding to the first payload characteristic, which defines how the request should be interpreted or responded to. This instruction may include prompt formatting rules, response style preferences, system directives, or AI-specific generation constraints.

Once the first model instruction is identified, the system then determines a second model instruction that differs from the first while maintaining the request's underlying intent. This alternative instruction may be derived by adjusting response length, changing formality levels, modifying verbosity, emphasizing specific entities, or altering the model's decision-making criteria. For example, if the original request is “Explain quantum mechanics.” with a first model instruction set to generate a concise answer, the system may modify the instruction to generate a detailed, step-by-step explanation. Alternatively, if the first model instruction requires a neutral tone, the second instruction may prompt the system to generate a more engaging or simplified version for beginners.

Using the second model instruction, the system then determines a first alternative payload characteristic for a first remaining request, ensuring that the modified request remains within the first cycle cluster while testing different response generation strategies. The system may achieve this by applying alternative AI prompt engineering techniques, using reinforcement learning-based instruction fine-tuning, adjusting temperature or top-k/top-p sampling parameters, or employing structured prompt modifications. Additionally, the system may validate the semantic equivalence of the responses using similarity scoring, intent classification models, or contextual coherence evaluations to ensure that the model instruction changes do not distort the intended response.

By systematically generating alternative payload characteristics through model instruction variations, the system enhances the flexibility, personalization, and adaptability of the request/response application. This approach ensures that the model can respond effectively across different instruction styles, optimize its response strategies based on user preferences, and adapt to diverse conversational requirements, ultimately improving overall system performance and user satisfaction.

At step 506, process 500 (e.g., using one or more components described above) determines a cycle completion criterion. For example, the system may determine a cycle completion criterion for a first response/request cycle based on the first cycle cluster. A system may determine a cycle completion criterion for a first request/response cycle based on the first cycle cluster by evaluating predefined conditions that indicate whether the interaction has reached a logical stopping point. These criteria may be derived from the intent, structure, and context of the requests within the cluster, ensuring that responses align with the expected conversational flow. The system may use natural language processing (NLP) models, rule-based heuristics, or machine learning-based evaluations to assess whether the response satisfies the request's intent, retains contextual coherence, and meets accuracy and relevancy benchmarks.

To establish the cycle completion criterion, the system may compare the generated response to a set of expected or reference responses within the first cycle cluster. If the response meets a predefined similarity threshold—such as a semantic similarity score (e.g., cosine similarity, BLEU score, or BERT embeddings)—the system may determine that the request/response cycle is complete. Alternatively, the system may define context-based stopping conditions, such as ensuring that all required information has been provided or confirming that the user's intent has been fully addressed. If the chatbot's response requires additional clarification or fails to resolve ambiguity, the system may determine that the cycle should continue with further exchanges.

Other completion criteria may include response correctness, accuracy, latency, and coherence metrics. The system may track whether the chatbot has successfully identified and processed the request's payload characteristics and maintained consistency with prior exchanges. Additionally, it may monitor user engagement signals, such as whether the user provides a follow-up response or confirms satisfaction with the chatbot's answer. If an unresolved query or conversational dead-end is detected, the system may determine that the cycle remains incomplete and trigger additional interactions.

By dynamically adjusting the cycle completion criterion based on the structure and intent of the first cycle cluster, the system enhances its ability to manage complex dialogues, ensure conversational completeness, and optimize chatbot performance. This approach allows the system to adapt to various interaction patterns, improve response accuracy, and refine the overall user experience in request/response applications.

At step 508, process 500 (e.g., using one or more components described above) assigns the cycle completion criterion. For example, the system may assign the cycle completion criterion to each of the plurality of requests. The system may assign the cycle completion criterion to each of the plurality of requests by updating metadata, database records, or structured logs that track the request/response cycle's progress and evaluation metrics. This process allows the system to systematically monitor and enforce stopping conditions for each request while ensuring consistency in response validation and conversational flow. The system may leverage database management systems (DBMS), key-value stores, or metadata tagging to associate each request with its respective completion criterion, ensuring that the assigned conditions are retrievable for future reference, performance tracking, and model improvement. One approach the system may use is metadata tagging, where it attaches completion-related attributes—such as response accuracy, relevancy score, cycle status, or confidence threshold—to each request entry. These metadata fields may be updated dynamically as the system evaluates responses in real time. If a request meets its assigned cycle completion criterion, the system may mark it as completed, whereas unresolved or ambiguous responses may trigger a “needs follow-up” status, prompting additional clarification steps before concluding the cycle.

In database-driven implementations, the system may store each request/response pair in structured tables or document-based storage solutions, where a “completion_status” field may be updated based on the system's evaluation. The system may also maintain versioned records to track how responses evolve over multiple iterations, allowing developers to analyze completion trends and fine-tune chatbot performance. Additionally, for systems that operate using machine learning models, completion criteria assignments may be logged as training data, enabling the chatbot to improve its context retention, response accuracy, and decision-making in future interactions.

To ensure seamless integration across multiple request/response cycles, the system may also use API calls, event-driven triggers, or message queues to propagate completion status updates across interconnected services. For example, if a chatbot interacts with a testing framework, the system may send completion signals via an API endpoint, enabling automated evaluation workflows to adjust scoring, trigger further tests, or log performance results. By assigning cycle completion criteria through structured data updates, systematic metadata tagging, and real-time database modifications, the system ensures that each request adheres to well-defined evaluation conditions, leading to improved response validation, conversational consistency, and overall chatbot effectiveness.

At step 510, process 500 (e.g., using one or more components described above) updates an application using the plurality of requests. For example, the system may update a first request/response application by inputting each of the plurality of requests into the first request/response application to receive respective responses, comparing each of the respective responses to the cycle completion criterion, and modifying parameters of the first request/response application based on comparing each of the respective responses to the cycle completion criterion.

The system may input each of the plurality of requests into the first request/response application to receive respective responses. For example, the system may input each of the plurality of requests into the first request/response application to receive respective responses by systematically processing each request through an automated pipeline that simulates user interactions. This process may involve sending each request individually or in batches to the application's input interface, which could be an API endpoint, a chatbot interface, a command-line utility, or another interactive system. The system may use scripted automation, testing frameworks, or machine learning-driven simulators to ensure that each request is formatted correctly and follows the intended request/response cycle.

The system may compare each of the respective responses to the cycle completion criterion. For example, once a request is input into the application, the system waits for a respective response generated by the application based on its underlying processing logic, whether that involves rule-based algorithms, natural language processing (NLP) models, database lookups, or AI-driven response generation. The response is then captured and stored, along with relevant metadata such as response time, confidence scores, error logs, and conversational context identifiers. If the request/response application supports asynchronous processing, the system may monitor the application's response queue or polling mechanism to retrieve responses when they become available. To ensure that responses are correctly associated with their corresponding requests, the system may maintain a structured logging or tracking system that records request IDs, timestamps, and other unique identifiers. Additionally, the system may preprocess requests—such as normalizing text, encoding special characters, or applying tokenization—before sending them to ensure compatibility with the request/response application's processing requirements.

In some embodiments, the system may determine the cycle completion criterion for the first response/request cycle based on the first cycle cluster by determining a threshold number of responses for response/request cycles, wherein comparing each of the respective responses to the cycle completion criterion by determining whether a respective number of current responses in a current response/request cycle for each of the respective responses corresponds to the threshold number of responses.

For example, the system may determine the cycle completion criterion for the first request/response cycle based on the first cycle cluster by establishing a threshold number of responses that defines when a response/request cycle should be considered complete. This threshold may be determined dynamically or predefined based on historical data, system rules, or machine learning-based optimization techniques. The system analyzes the first cycle cluster, which contains requests with similar payload characteristics, intents, or complexity, to determine the appropriate response threshold. If the requests in the cluster historically require a single response to satisfy user intent (e.g., a factual query like “What is the capital of France?”), the system may set the threshold to one response. However, if the requests involve multi-turn interactions requiring clarification or additional information (e.g., “Help me troubleshoot my internet connection”), the system may establish a higher threshold.

Once the threshold number of responses is determined, the system applies this criterion when comparing each respective response to evaluate whether a current response/request cycle has met the stopping condition. The system tracks the number of responses generated within the cycle and continuously checks whether this count meets or exceeds the threshold number of responses assigned to the cluster. If a request has received fewer than the threshold responses, the system may classify the cycle as incomplete, prompting the request/response application to continue processing or seek additional clarification from the user. Conversely, if the number of responses in the current cycle matches or exceeds the threshold, the system may determine that the cycle completion criterion has been met, marking the interaction as finalized.

Additionally, the system may refine the threshold dynamically by analyzing user feedback, error patterns, or response accuracy metrics. If a threshold is frequently exceeded or results in incomplete conversations, the system may adjust it to better align with real-world conversational needs. This adaptive approach ensures that the request/response cycle remains efficient, contextually aware, and optimized for both accuracy and user experience.

In some embodiments, the system may determine the cycle completion criterion for the first response/request cycle based on the first cycle cluster by determining a threshold time limit for response/request cycles, wherein comparing each of the respective responses to the cycle completion criterion by determining whether a respective current time length in a current response/request cycle for each of the respective responses corresponds to the threshold time limit.

For example, the system may determine the cycle completion criterion for the first request/response cycle based on the first cycle cluster by establishing a threshold time limit that defines when the cycle should be considered complete. This time limit may be determined based on historical interaction data, system policies, machine learning models, or predefined rules that account for typical response times required to resolve different types of requests. The system analyzes the first cycle cluster, which contains similar requests, to determine an appropriate time-based stopping condition. For example, simple queries requiring quick responses (e.g., “What is the current temperature?”) may have a low threshold time limit, whereas complex, multi-turn interactions (e.g., “Guide me through setting up my Wi-Fi router”) may require a longer threshold to allow for follow-up exchanges.

Once the system establishes the threshold time limit, it applies this criterion when comparing each respective response to determine if the current response/request cycle is complete. The system continuously monitors the elapsed time of each cycle from the moment the initial request is received. If the current response/request cycle's time length is still below the threshold time limit, the system may classify the cycle as ongoing, allowing for further responses or interactions. However, if the elapsed time in the current cycle meets or exceeds the threshold time limit, the system may determine that the cycle completion criterion has been met, marking the interaction as finalized or expired.

Additionally, the system may incorporate dynamic adjustments to the threshold time limit based on real-time conditions, such as network latency, system load, or user activity patterns. If a request/response cycle frequently exceeds the time limit due to slow processing times or lengthy user interactions, the system may extend the threshold accordingly. Conversely, if users tend to disengage before the limit is reached, the system may shorten the threshold to improve efficiency. By using a threshold time limit as a cycle completion criterion, the system ensures that request/response cycles remain timely, contextually appropriate, and optimized for user experience, preventing unnecessary delays while maintaining conversational integrity.

In some embodiments, the system may determine the cycle completion criterion for the first response/request cycle based on the first cycle cluster by determining a threshold repetition limit in responses for response/request cycles, wherein comparing each of the respective responses to the cycle completion criterion by determining whether a respective current repetition level in a current response/request cycle for each of the respective responses corresponds to the threshold repetition limit.

For example, the system may determine the cycle completion criterion for the first request/response cycle based on the first cycle cluster by setting a threshold repetition limit for responses within a response/request cycle. This threshold defines how many times a chatbot or system may generate a repetitive response before the cycle is considered complete or flagged for review. The system may determine this limit by analyzing historical conversation patterns, user engagement data, or predefined rules that indicate when excessive repetition signals conversation stagnation, inefficiency, or failure to resolve the user's request.

To implement this criterion, the system tracks response patterns within each response/request cycle. If a response or a variation of the same response is repeated multiple times, the system increments a repetition counter. The system then compares the current repetition level within the cycle to the threshold repetition limit. If the number of repeated responses remains below the threshold, the system may allow the interaction to continue, assuming that additional responses may lead to resolution. However, if the threshold repetition limit is met or exceeded, the system may classify the cycle as completed or in need of intervention, triggering corrective actions such as redirecting the request, escalating to a human agent, or generating an alternative response strategy.

Additionally, the system may dynamically adjust the repetition threshold based on conversation context, user behavior, or error detection mechanisms. If excessive repetition frequently leads to user frustration or disengagement, the system may lower the threshold to identify problematic cycles earlier. Conversely, in cases where repetition is necessary for clarification or rephrasing (e.g., troubleshooting or step-by-step guidance), the system may increase the threshold to accommodate longer exchanges. By using a threshold repetition limit as a completion criterion, the system ensures that response/request cycles remain productive, context-aware, and free from unnecessary redundancy, improving chatbot efficiency and user satisfaction.

In some embodiments, the system may compare each of the respective responses to the cycle completion criterion by determining a respective ending condition corresponding to each of the respective responses, comparing the respective ending condition to the cycle completion criterion, and determining an accuracy metric for each of the respective responses based on comparing the respective ending condition to the cycle completion criterion.

The system may modify parameters of the first request/response application based on comparing each of the respective responses to the cycle completion criterion. For example, to improve performance, the system may modify parameters of the first request/response application based on this comparative analysis. This modification process may involve adjusting model weights, refining intent classification algorithms, re-training the system with augmented data, or fine-tuning response generation rules. For machine learning-based applications, the system may use reinforcement learning techniques, feeding misclassified or low-scoring responses back into the training pipeline to enhance the model's predictive accuracy. If the application operates with a rule-based framework, modifications may include updating predefined response templates, expanding entity recognition databases, or refining conversational flow logic. Additionally, the system may employ an automated feedback loop, continuously repeating this evaluation and adjustment process to iteratively enhance the request/response application over time. By leveraging real-time performance tracking, dynamic parameter updates, and iterative model training, the system ensures that the request/response application improves its accuracy, efficiency, and contextual adaptability, ultimately leading to more reliable and human-like conversational interactions.

For example, the system may update a first request/response application by systematically processing a plurality of requests, evaluating their responses against a cycle completion criterion, and adjusting the application's parameters based on the comparison results. The update process begins by inputting each request from the dataset into the first request/response application, allowing the system to generate respective responses for evaluation. These responses may be logged and analyzed using natural language processing (NLP) models, rule-based heuristics, or statistical comparisons to assess their accuracy, relevancy, and adherence to expected conversational patterns.

Once responses are generated, the system may compare each respective response to the predefined cycle completion criterion, which may include correctness thresholds, intent-matching confidence scores, semantic similarity benchmarks, response latency, and contextual consistency metrics. If a response meets the completion criterion, it is considered valid, confirming that the request/response application handled the input correctly. However, if the response fails to meet the criterion—such as generating incorrect information, misinterpreting intent, or lacking contextual awareness—the system identifies the specific deficiencies that need improvement.

In some embodiments, the system may modify the parameters of the first request/response application based on comparing each of the respective responses to the cycle completion criterion by determining a first response corpus for the first request/response application and modifying the first response corpus. The system may modify the parameters of the first request/response application by comparing each of the respective responses to the cycle completion criterion and adjusting the first response corpus to enhance the accuracy and effectiveness of future responses. The first response corpus is a structured dataset containing predefined responses, model-generated outputs, contextual variations, and user feedback data that the request/response application relies on for generating replies. To improve system performance, the system must first determine the first response corpus, identifying its existing content, coverage gaps, and inconsistencies based on past interactions, training data, and evaluation metrics.

Once the first response corpus is identified, the system then analyzes the generated responses by comparing them to the cycle completion criterion, which may include accuracy benchmarks, semantic similarity thresholds, relevancy scores, latency requirements, or user engagement metrics. If the responses meet the completion criterion, the system may confirm that the existing response corpus is functioning correctly. However, if responses fail to meet expectations—such as providing incorrect, incomplete, or irrelevant information—the system may modify the first response corpus to improve response accuracy.

The modification process may involve several adjustments, such as adding new response variations, restructuring answers to improve clarity, removing outdated or redundant responses, or updating response templates based on linguistic trends. The system may also incorporate real-time user feedback, using reinforcement learning or supervised fine-tuning techniques to enhance the quality and contextual appropriateness of the corpus. Additionally, NLP models may be employed to automatically generate alternative responses, ensuring that the request/response application adapts to different phrasing, user intents, and contextual shifts.

By continuously refining the first response corpus, the system enhances the adaptability, accuracy, and responsiveness of the request/response application. This iterative learning process ensures that the system remains relevant, context-aware, and capable of handling a diverse range of user queries effectively, ultimately improving the overall user experience.

In some embodiments, the system may modify the parameters of the first request/response application based on comparing each of the respective responses to the cycle completion criterion by determining a first data source for the first request/response application and modifying the first data source. For example, the system may modify the parameters of the first request/response application by comparing each of the respective responses to the cycle completion criterion and adjusting the first data source to enhance the application's performance and accuracy. The first data source is a repository of information that the request/response application relies on to generate responses, which may include structured databases, knowledge graphs, language models, API integrations, or real-time web data. To optimize response generation, the system must first determine the first data source, identifying the sources of information currently being used and evaluating their completeness, accuracy, and relevance in relation to user queries.

Once the first data source is identified, the system then analyzes the generated responses by comparing them against the cycle completion criterion, which may include factors such as semantic similarity to expected answers, factual correctness, response latency, confidence scores, and contextual coherence. If responses are found to be inaccurate, outdated, or insufficiently detailed, the system may modify the first data source to improve response generation.

Modifications to the first data source may include expanding the dataset with additional verified information, updating existing records to reflect the latest facts, removing incorrect or misleading data, or enhancing data retrieval mechanisms to ensure that responses pull from the most relevant sources. In AI-powered applications, the system may also fine-tune a language model using a more diverse dataset or integrate external APIs to supplement the application's knowledge base with real-time data (e.g., financial market updates, weather conditions, or news feeds). Additionally, metadata tagging and indexing improvements may be applied to refine how the system retrieves and ranks relevant data during response generation.

By continuously refining the first data source, the system enhances the accuracy, adaptability, and contextual awareness of the request/response application. This iterative optimization ensures that responses are factually correct, contextually relevant, and aligned with user expectations, ultimately improving the overall efficiency, reliability, and user satisfaction of the application.

In some embodiments, the system may modify the parameters of the first request/response application based on comparing each of the respective responses to the cycle completion criterion by determining a first natural language processing engine used for the first request/response application and replacing the first natural language processing engine with a second natural language processing engine. For example, system may modify the parameters of the first request/response application by comparing each of the respective responses to the cycle completion criterion and determining whether the first natural language processing (NLP) engine used in the application is adequately meeting performance expectations. The first NLP engine is responsible for understanding user inputs, identifying intent, generating responses, and maintaining conversational context. It may leverage rule-based processing, statistical models, deep learning-based transformers, or hybrid approaches to process user queries. To optimize response accuracy and efficiency, the system must first evaluate the performance of the first NLP engine by analyzing how well its responses align with the cycle completion criterion, which may include response accuracy, semantic similarity, relevancy scores, latency, user engagement metrics, and overall coherence.

If the system determines that the first NLP engine is underperforming—such as generating irrelevant, inconsistent, or low-confidence responses—it may decide to replace the first NLP engine with a second NLP engine that better meets the application's requirements. The second NLP engine may provide improved intent recognition, enhanced contextual understanding, faster response times, or greater adaptability to linguistic variations. This replacement process may involve migrating existing training data, fine-tuning the new engine to align with previous interactions, updating API integrations, and adjusting model parameters to match the response/handling logic of the first request/response application.

The transition to the second NLP engine may also require retraining or additional data augmentation to ensure that the new system maintains continuity with past interactions and does not disrupt existing workflows. Additionally, the system may perform A/B testing between the first and second NLP engines to measure performance improvements before fully transitioning. If necessary, hybrid approaches may be adopted, where the first and second NLP engines work together—such as using a rule-based engine for structured queries and a deep learning model for unstructured, conversational inputs.

By replacing the first NLP engine with a second NLP engine, the system enhances the accuracy, fluency, and adaptability of the request/response application, ensuring that it can process diverse user queries, maintain contextual consistency, and generate high-quality responses more effectively. This iterative improvement leads to greater user satisfaction, increased engagement, and overall system efficiency in handling natural language interactions.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for training request/response applications on serial request/response cycles.
2. The method of any one of the preceding embodiments, further comprising: receiving a first request, wherein the first request has a first payload characteristic corresponding to a first cycle cluster; generating for each remaining request in a plurality of requests a respective alternative payload characteristic corresponding to the first cycle cluster; determining a cycle completion criterion for a first response/request cycle based on the first cycle cluster; assigning the cycle completion criterion to each of the plurality of requests; updating a first request/response application by: inputting each of the plurality of requests into the first request/response application to receive respective responses; comparing each of the respective responses to the cycle completion criterion; and modifying parameters of the first request/response application based on comparing each of the respective responses to the cycle completion criterion.
3. The method of any one of the preceding embodiments, wherein generating for each remaining request in the plurality of requests the respective alternative payload characteristic corresponding to the first cycle cluster further comprises: determining a first keyword corresponding to the first payload characteristic; determining a second keyword based on the second keyword being a synonym of the first keyword; and determining a first alternative payload characteristic for a first remaining request in the plurality of requests.
4. The method of any one of the preceding embodiments, wherein generating for each remaining request in the plurality of requests the respective alternative payload characteristic corresponding to the first cycle cluster further comprises: determining a first sentence structure and first sentence meaning corresponding to the first payload characteristic; determining a second sentence structure that is different from the first sentence structure; and determining a first alternative payload characteristic for a first remaining request in the plurality of requests based on the second sentence structure and the first sentence meaning.
5. The method of any one of the preceding embodiments, wherein generating for each remaining request in the plurality of requests the respective alternative payload characteristic corresponding to the first cycle cluster further comprises: determining a first prompt detail level corresponding to the first payload characteristic; determining a second prompt detail level that is different from the first prompt detail level; and determining a first alternative payload characteristic for a first remaining request in the plurality of requests based on the second prompt detail level.
6. The method of any one of the preceding embodiments, wherein generating for each remaining request in the plurality of requests the respective alternative payload characteristic corresponding to the first cycle cluster further comprises: determining a first prompt chaining threshold corresponding to the first payload characteristic; determining a second prompt chaining threshold that is different from the first prompt chaining threshold; and determining a first alternative payload characteristic for a first remaining request in the plurality of requests based on the second prompt chaining threshold.
7. The method of any one of the preceding embodiments, wherein generating for each remaining request in the plurality of requests the respective alternative payload characteristic corresponding to the first cycle cluster further comprises: determining a first context corresponding to the first payload characteristic; determining a second context that is different from the first context; and determining a first alternative payload characteristic for a first remaining request in the plurality of requests based on the second context.
8. The method of any one of the preceding embodiments, wherein generating for each remaining request in the plurality of requests the respective alternative payload characteristic corresponding to the first cycle cluster further comprises: determining a first model instruction corresponding to the first payload characteristic; determining a second model instruction that is different from the first model instruction; and determining a first alternative payload characteristic for a first remaining request in the plurality of requests based on the second model instruction.
9. The method of any one of the preceding embodiments, wherein determining the cycle completion criterion for the first response/request cycle based on the first cycle cluster comprises determining a first keyword, and wherein comparing each of the respective responses to the cycle completion criterion further comprises determining whether a respective word in each of the respective responses corresponds to the first keyword.
10. The method of any one of the preceding embodiments, wherein determining the cycle completion criterion for the first response/request cycle based on the first cycle cluster comprises determining a threshold number of responses for response/request cycles, and wherein comparing each of the respective responses to the cycle completion criterion further comprises determining whether a respective number of current responses in a current response/request cycle for each of the respective responses corresponds to the threshold number of responses.
11. The method of any one of the preceding embodiments, wherein determining the cycle completion criterion for the first response/request cycle based on the first cycle cluster comprises determining a threshold time limit for response/request cycles, and wherein comparing each of the respective responses to the cycle completion criterion further comprises determining whether a respective current time length in a current response/request cycle for each of the respective responses corresponds to the threshold time limit.
12. The method of any one of the preceding embodiments, wherein determining the cycle completion criterion for the first response/request cycle based on the first cycle cluster comprises determining a threshold repetition limit in responses for response/request cycles, and wherein comparing each of the respective responses to the cycle completion criterion further comprises determining whether a respective current repetition level in a current response/request cycle for each of the respective responses corresponds to the threshold repetition limit.
13. The method of any one of the preceding embodiments, wherein comparing each of the respective responses to the cycle completion criterion further comprises: determining a respective ending condition corresponding to each of the respective responses; comparing the respective ending condition to the cycle completion criterion; and determining an accuracy metric for each of the respective responses based on comparing the respective ending condition to the cycle completion criterion.
14. The method of any one of the preceding embodiments, wherein modifying the parameters of the first request/response application based on comparing each of the respective responses to the cycle completion criterion further comprises: determining a first response corpus for the first request/response application; and modifying the first response corpus.
15. The method of any one of the preceding embodiments, wherein modifying the parameters of the first request/response application based on comparing each of the respective responses to the cycle completion criterion further comprises: determining a first data source for the first request/response application; and modifying the first data source.
16. The method of any one of the preceding embodiments, wherein modifying the parameters of the first request/response application based on comparing each of the respective responses to the cycle completion criterion further comprises: determining a first natural language processing engine used for the first request/response application; and replacing the first natural language processing engine with a second natural language processing engine.
17. One or more non-transitory, computer-readable mediums storing instructions that, when executed by a data processing apparatus, cause the data processing apparatus to perform operations comprising those of any of embodiments 1-16.
18. A system comprising one or more processors; and memory storing instructions that, when executed by the processors, cause the processors to effectuate operations comprising those of any of embodiments 1-16.
19. A system comprising means for performing any of embodiments 1-16.

What is claimed is:

1. A system for updating Application Programming Interface (“API”) request/response applications used to facilitate secure API request/response cycles across secured computer networks using a common cryptographic security protocol, the system comprising:
one or more processors; and
one or more non-transitory, computer-readable media having instructions recorded thereon that when executed by the one or more processors cause operations comprising:
receiving, from a first computer on a first computer network, a first secured API request of a plurality of secured API requests, wherein the first secured API request has a first payload characteristic corresponding to a first payload cluster, and wherein the first secured API request comprises a first cryptographic security protocol;
generating for each remaining secured API request in the plurality of secured API requests a respective alternative payload characteristic corresponding to the first payload cluster, and wherein the plurality of secured API requests comprises the first cryptographic security protocol;
determining a cycle completion criterion for a first API response/request cycle based on the first payload cluster;
assigning the cycle completion criterion to each of the plurality of secured API requests;
updating a first API request/response application by:
inputting each of the plurality of secured API requests into the first API request/response application on the first computer to receive respective API responses from the first computer;
comparing each of the respective API responses to the cycle completion criterion; and
modifying parameters of the first API request/response application based on comparing each of the respective API responses to the cycle completion criterion.

2. A method for training request/response applications on serial request/response cycles, the method comprising:
receiving a first request, wherein the first request has a first payload characteristic corresponding to a first cycle cluster;
generating for each remaining request in a plurality of requests a respective alternative payload characteristic corresponding to the first cycle cluster;
determining a cycle completion criterion for a first response/request cycle based on the first cycle cluster;
assigning the cycle completion criterion to each of the plurality of requests;
updating a first request/response application by:
inputting each of the plurality of requests into the first request/response application to receive respective responses;
comparing each of the respective responses to the cycle completion criterion; and
modifying parameters of the first request/response application based on comparing each of the respective responses to the cycle completion criterion.

3. The method of claim 2, wherein generating for each remaining request in the plurality of requests the respective alternative payload characteristic corresponding to the first cycle cluster further comprises:
determining a first keyword corresponding to the first payload characteristic;
determining a second keyword based on the second keyword being a synonym of the first keyword; and
determining a first alternative payload characteristic for a first remaining request in the plurality of requests.

4. The method of claim 2, wherein generating for each remaining request in the plurality of requests the respective alternative payload characteristic corresponding to the first cycle cluster further comprises:
determining a first sentence structure and first sentence meaning corresponding to the first payload characteristic;
determining a second sentence structure that is different from the first sentence structure; and
determining a first alternative payload characteristic for a first remaining request in the plurality of requests based on the second sentence structure and the first sentence meaning.

5. The method of claim 2, wherein generating for each remaining request in the plurality of requests the respective alternative payload characteristic corresponding to the first cycle cluster further comprises:
determining a first prompt detail level corresponding to the first payload characteristic;
determining a second prompt detail level that is different from the first prompt detail level; and
determining a first alternative payload characteristic for a first remaining request in the plurality of requests based on the second prompt detail level.

6. The method of claim 2, wherein generating for each remaining request in the plurality of requests the respective alternative payload characteristic corresponding to the first cycle cluster further comprises:
determining a first prompt chaining threshold corresponding to the first payload characteristic;
determining a second prompt chaining threshold that is different from the first prompt chaining threshold; and
determining a first alternative payload characteristic for a first remaining request in the plurality of requests based on the second prompt chaining threshold.

7. The method of claim 2, wherein generating for each remaining request in the plurality of requests the respective alternative payload characteristic corresponding to the first cycle cluster further comprises:
determining a first context corresponding to the first payload characteristic;
determining a second context that is different from the first context; and
determining a first alternative payload characteristic for a first remaining request in the plurality of requests based on the second context.

8. The method of claim 2, wherein generating for each remaining request in the plurality of requests the respective alternative payload characteristic corresponding to the first cycle cluster further comprises:
determining a first model instruction corresponding to the first payload characteristic;
determining a second model instruction that is different from the first model instruction; and
determining a first alternative payload characteristic for a first remaining request in the plurality of requests based on the second model instruction.

9. The method of claim 2, wherein determining the cycle completion criterion for the first response/request cycle based on the first cycle cluster comprises determining a first keyword, and wherein comparing each of the respective responses to the cycle completion criterion further comprises determining whether a respective word in each of the respective responses corresponds to the first keyword.

10. The method of claim 2, wherein determining the cycle completion criterion for the first response/request cycle based on the first cycle cluster comprises determining a threshold number of responses for response/request cycles, and wherein comparing each of the respective responses to the cycle completion criterion further comprises determining whether a respective number of current responses in a current response/request cycle for each of the respective responses corresponds to the threshold number of responses.

11. The method of claim 2, wherein determining the cycle completion criterion for the first response/request cycle based on the first cycle cluster comprises determining a threshold time limit for response/request cycles, and wherein comparing each of the respective responses to the cycle completion criterion further comprises determining whether a respective current time length in a current response/request cycle for each of the respective responses corresponds to the threshold time limit.

12. The method of claim 2, wherein determining the cycle completion criterion for the first response/request cycle based on the first cycle cluster comprises determining a threshold repetition limit in responses for response/request cycles, and wherein comparing each of the respective responses to the cycle completion criterion further comprises determining whether a respective current repetition level in a current response/request cycle for each of the respective responses corresponds to the threshold repetition limit.

13. The method of claim 2, wherein comparing each of the respective responses to the cycle completion criterion further comprises:
determining a respective ending condition corresponding to each of the respective responses;
comparing the respective ending condition to the cycle completion criterion; and
determining an accuracy metric for each of the respective responses based on comparing the respective ending condition to the cycle completion criterion.

14. The method of claim 2, wherein modifying the parameters of the first request/response application based on comparing each of the respective responses to the cycle completion criterion further comprises:
determining a first response corpus for the first request/response application; and
modifying the first response corpus.

15. The method of claim 2, wherein modifying the parameters of the first request/response application based on comparing each of the respective responses to the cycle completion criterion further comprises:
determining a first data source for the first request/response application; and
modifying the first data source.

16. The method of claim 2, wherein modifying the parameters of the first request/response application based on comparing each of the respective responses to the cycle completion criterion further comprises:
determining a first natural language processing engine used for the first request/response application; and
replacing the first natural language processing engine with a second natural language processing engine.

17. One or more non-transitory, computer-readable media having instructions recorded thereon that when executed by one or more processors cause operations comprising:
receiving a first request, wherein the first request has a first payload characteristic corresponding to a first cycle cluster;
generating for each remaining request in a plurality of requests a respective alternative payload characteristic corresponding to the first cycle cluster;
determining a cycle completion criterion for a first response/request cycle based on the first cycle cluster;
assigning the cycle completion criterion to each of the plurality of requests;
inputting each of the plurality of requests into request/response application to receive respective responses; and
comparing each of the respective responses to the cycle completion criterion.

18. The one or more non-transitory, computer-readable media of claim 17, wherein generating for each remaining request in the plurality of requests the respective alternative payload characteristic corresponding to the first cycle cluster further comprises:
determining a first keyword corresponding to the first payload characteristic;
determining a second keyword based on the second keyword being a synonym of the first keyword; and
determining a first alternative payload characteristic for a first remaining request in the plurality of requests.

19. The one or more non-transitory, computer-readable media of claim 17, wherein determining the cycle completion criterion for the first response/request cycle based on the first cycle cluster comprises determining a threshold repetition limit in responses for response/request cycles, and wherein comparing each of the respective responses to the cycle completion criterion further comprises determining whether a respective current repetition level in a current response/request cycle for each of the respective responses corresponds to the threshold repetition limit.

20. The one or more non-transitory, computer-readable media of claim 17, wherein comparing each of the respective responses to the cycle completion criterion further comprises:
determining a respective ending condition corresponding to each of the respective responses;
comparing the respective ending condition to the cycle completion criterion; and
determining an accuracy metric for each of the respective responses based on comparing the respective ending condition to the cycle completion criterion.
